(19) United States
(12) Patent Application Publication
(10) Pub. No.: US 2011/0033113 A1
(43) Pub. Date: Feb. 10, 2011

(54) ELECTRONIC APPARATUS AND IMAGE DATA DISPLAY METHOD

(75) Inventors: Tomonori SAKAGUCHI, Ome-shi (JP); Kohei MOMOSAKI, Mitaka-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/851,497

(22) Filed: Aug. 5, 2010

(30) Foreign Application Priority Data
Aug. 5, 2009 (JP) 2009-182694

(51) Int. Cl. G06K 9/46; G09G 5/00

(52) U.S. Cl. 382/190; 345/156

(57) ABSTRACT

According to one embodiment, an electronic apparatus includes an indexing module, a frame image extraction module, and a display controller. The indexing module is configured to create index information for moving image data. The frame image extraction module is configured to extract an image of a frame satisfying a predetermined extraction condition from the moving image data based on the index information. The display controller is configured to display the extracted image based on a predetermined display condition.

### CROSS-REFERENCE TO RELATED APPLICATIONS

This application is based upon and claims the benefit of priority from Japanese Patent Application No. 2009-182694, filed Aug. 5, 2009; the entire contents of which are incorporated herein by reference.

### FIELD

Embodiments described herein relate generally to a video data display control technique that is preferable for electronic apparatuses, for example, personal computers.

### BACKGROUND

In recent years, there have been a rapid increase in the number of pixels and a rapid size reduction for image pickup devices such as CCDs (Charge coupled devices) and CMOS (Complementary metal-oxide semiconductor) image sensors. Thus, moving images can now be taken even using a cellular phone or a notebook personal computer.

The most handy and common method for roughly checking a taken moving image is to carry out what is called high speed play. However, this method only uniformly reduces play time for the entire moving image. The method gives no consideration to what the user emphasizes in checking the moving image.

In contrast, for example, Jpn. Pat. Appln. KOKAI Publication No. 2008-283486 discloses an information processing apparatus formed so as to allow the user to note only a particular one of persons appearing in a video content so as to extract and reproduce portions of the video content corresponding to periods during which the person appears on a screen (paragraph “0007” and the like).

The information processing apparatus enables the user to check the moving image in the form of a digest version corresponding to a collection of the periods during which the person noted by the user appears.

Reproduction apparatuses called digital photo frames have recently been prevailing. The digital photo frame provides a function to sequentially display a plurality of still images at predetermined time intervals; the still images have been taken with, for example, a digital camera and stored in an SD (Secure Digital) memory card or the like. The digital photo frame is also utilized as a desktop accessory.

Not only for original taken still images but also original taken moving images, there has been a growing demand to display only still images of particular scenes in the moving image, for example, the scenes in which the person noted by the user appears, in the same manner as that in which the digital photo frame displays the images.

However, although a mechanism exists which extracts any scenes from the moving image as still images, much effort is required to search the moving image for a certain number of still images and extract the still images.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram showing the appearance of an electronic apparatus according to a first embodiment.

FIG. 2 is an exemplary diagram showing the system configuration of an electronic apparatus according to the first embodiment.

FIG. 3 is an exemplary block diagram showing the functional configuration of a TV application program operating on the electronic apparatus according to the first embodiment.

FIG. 4 is an exemplary diagram showing an example of the configuration of index information used by the TV application program operating on the electronic apparatus according to the first embodiment.

FIG. 5 is an exemplary diagram showing an example of a base screen for slide show creation displayed by the TV application program operating on the electronic apparatus according to the first embodiment.

FIG. 6 is an exemplary diagram showing an example of a setting screen for slide show creation displayed by the TV application program operating on the electronic apparatus according to the first embodiment.

FIG. 7 is an exemplary diagram showing a display example of a slide show displayed by the TV application program operating on the electronic apparatus according to the first embodiment.

FIG. 8 is an exemplary flowchart showing the procedure of a process for creating and displaying a slide show which process is executed by the TV application program operating on the electronic apparatus according to the first embodiment.

FIG. 9 is an exemplary diagram showing an example of the configuration of index information used by a TV application program operating on an electronic apparatus according to a second embodiment.

FIG. 10 is an exemplary diagram showing an example of a base screen for slide show creation displayed by the TV application program operating the electronic apparatus according to the second embodiment.

FIG. 11 is an exemplary flowchart showing the procedure of a process for creating and displaying a slide show which process is executed by the TV application program operating on the electronic apparatus according to the second embodiment.

### DETAILED DESCRIPTION

Various embodiments will be described hereinafter with reference to the accompanying drawings.

In general, according to one embodiment, an electronic apparatus includes an indexing module, a frame image extraction module, and a display controller. The indexing module is configured to create index information for moving image data. The frame image extraction module is configured to extract an image of a frame satisfying a predetermined extraction condition from the moving image data based on the index information. The display controller is configured to display the extracted image based on a predetermined display condition.

### First Embodiment

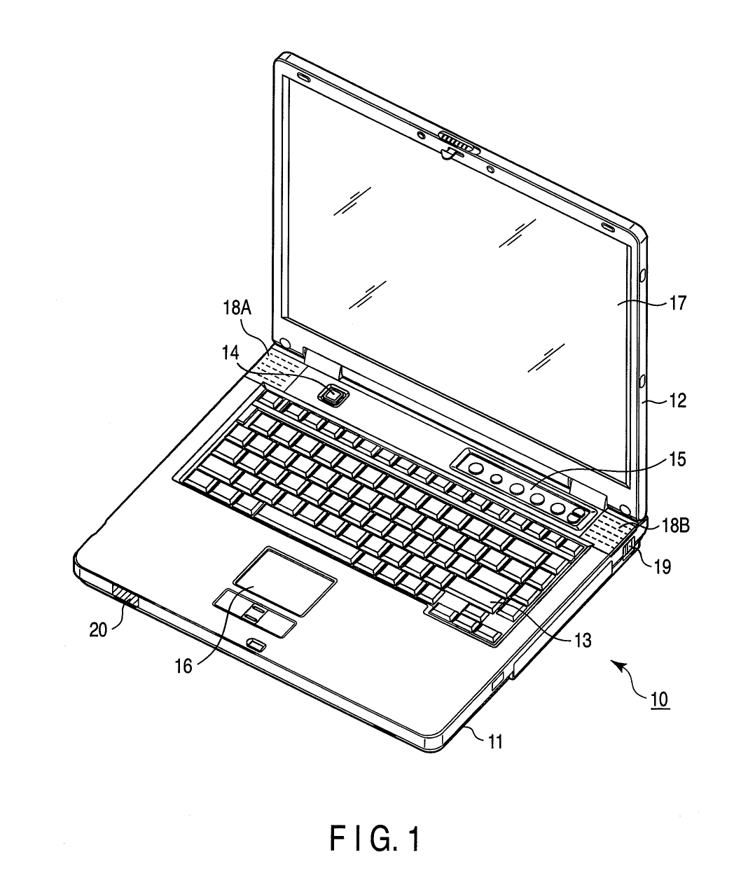

First, the configuration of an electronic apparatus according to a first embodiment will be described with reference to FIG. 1. The electronic apparatus is implemented as, for example, a notebook type personal computer 10.

The computer 10 provides a TV function to allow program data broadcast on broadcast waves or distributed through Internet moving image distribution service to be viewed and recorded. The TV function is implemented by a TV application program installed in the computer 10. The TV function also serves to record and reproduce video data input by an external AV apparatus. The computer 10 includes a mechanism for allowing only the user's desired frames in moving image data included in various video content data to be displayed in the same manner as that in which what is called a digital photo frame displays images; the video content data include recorded program data, recorded externally-input video data, or video data loaded from an external video camera with which the video has been taken and recorded. This will be described below.

FIG. 1 is an exemplary perspective view of the computer 10 in which a display unit is open. The computer 10 includes a computer main body 11 and a display unit 12. The display unit 12 incorporates a display apparatus including TFT-LCD (Thin film transistor-liquid crystal display) 17. The display unit 12 is attached to the computer main body 11 so as to be pivotally movable between an open position where the top surface of the computer main body 11 is exposed and a closed position where the top surface of the computer main body 11 is covered.

The computer main body 11 includes a thin box-like housing. The housing includes a keyboard 13, a power button 14 being configured to power on and off the computer 10, an input operation panel 15, a touch pad 16, and speakers 18A and 18B all arranged on the top surface of the housing. Various operation buttons, for example, a TV button and a channel switching button, are provided on the input operation panel 15.

Furthermore, an input terminal 19 is provided on, for example, the right side surface of the computer main body 11 such that program data broadcast on broadcast waves and program data distributed through Internet moving image distribution services can be input through the input terminal 19. The input terminal 19 is connected to an antenna or a CATV network via a cable. Furthermore, the input terminal 19 can be used to allow video data from an external AV apparatus to be input to the computer main body 11.

A remote control unit interface module 20 is provided on the front surface of the computer main body 11 to communicate with an external remote control unit configured to remotely control the TV function of the computer 10. The remote control unit interface module 20 includes, for example, an infrared signal reception module.

Furthermore, an external display connection terminal (not shown in the drawings) corresponding to, for example, an HDMI (High definition multimedia interface) standard is provided on the rear surface of the computer main body 11. The external display connection terminal is used to output digital video signals to an external display.

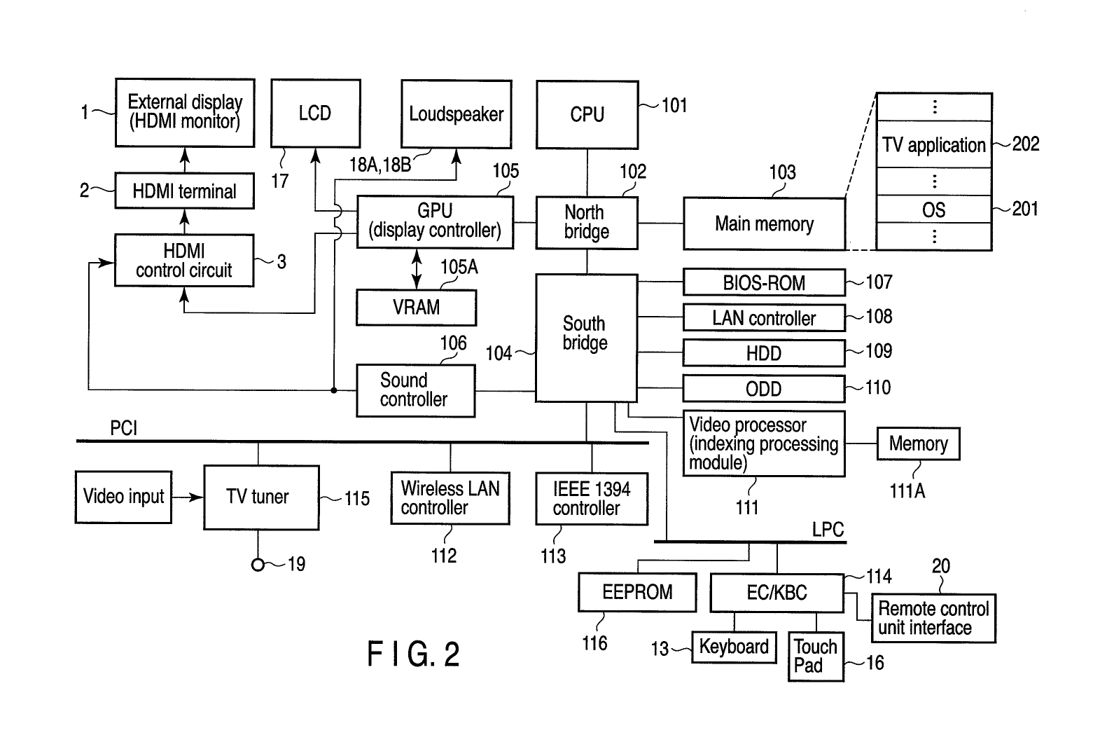

FIG. 2 is an exempraly diagram showing the system configuration of the computer 10.

As shown in FIG. 2, the computer 10 includes CPU (Central processing unit) 101, a north bridge 102, a main memory 103, a south bridge 104, GPU (Graphics processing unit) 105, VRAM (Video RAM: Random access memory) 105A, a sound controller 106, BIOS-ROM (Basic input/output system-read only memory) 107, a LAN (Local area network) controller 108, HDD (Hard disk drive) 109, ODD (Optical disc drive) 110, a video processor 111, a memory 111A, a wireless LAN controller 112, an IEEE 1394 controller 113, an EC/KBC (Embedded controller/keyboard controller) 114, a TV tuner 115, and EEPROM (Electrically erasable programmable ROM) 116.

CPU 101 is a processor configured to control the operation of the computer 10 and to execute an operating system (OS) 201 and various application programs such as a TV application program 202; the operating system and the application programs are loaded from HDD 109 into the main memory 103. The TV application program 202 is software configured to execute the TV function. The TV application program 202 executes, for example, a live reproduction process for allowing program data received by the TV tuner 115 to be viewed, a recording process for recording received program data in HDD 109, and a reproduction process for reproducing various video content data program data and video data recorded in HDD 109. CPU 101 also executes BIOS stored in BIOS-ROM 107. BIOS is a program for controlling hardware.

The north bridge 102 is a bridge device configured to connect a local bus for CPU 101 and the south bridge 104. The north bridge 102 includes a memory controller configured to control accesses to the main memory 103. The north bridge 102 also provides a function to communicate with GPU 105 via a serial bus complying with the PCI EXPRESS standard.

GPU 105 is a display controller configured to control LCD 17 used as a display monitor for the computer 10. Display signals generated by GPU 105 are transmitted to LCD 17. GPU 105 can also transmit digital video signals to an external display apparatus 1 via an HDMI control circuit 3 and an HDMI terminal 2.

The HDMI terminal 2 is the above-described external display connection terminal. The HDMI terminal 2 allows uncompressed digital video signals and digital audio signals to be transmitted to the external display apparatus 1 such as a television via one cable. The HDMI control circuit 3 is an interface configured to transmit digital video signals to the external display apparatus 1 called an HDMI monitor, via the HDMI terminal 2.

The south bridge 104 controls devices on a PCI (Peripheral component interconnect) bus and devices on an LPC (Low pin count) bus. The south bridge 104 also includes an IDE (Integrated drive electronics) controller configured to control HDD 109 and ODD 110. The south bridge 104 further provides a function to communicate with the sound controller 106. Furthermore, the video processor 111 is connected to the south bridge 104 via a serial bus complying with the PCI EXPRESS standard.

The video processor 111 is a processor configured to execute various indexing processes for creating index information that allows a user to efficiently search video content data for a desired scene. The video processor 111 functions as an indexing processing module for executing a video indexing process. In the video indexing process, the video processor 111 extracts a plurality of face images from moving image data included in video content data, and outputs, for example, time stamp information indicative of points in time when the extracted face images appear in the video content data. The face images are extracted by, for example, a face detection process of detecting a face area in each frame of the moving image data and a clipping process of clipping the detected face area from the frame. The face area can be detected by, for example, analyzing the features of the image of each frame and searching for an area with features similar to those of a prepared face image feature sample. The face image feature sample is feature data obtained by statistically processing the face image features of many persons.

The video processor 111 further executes an audio indexing process. In the audio indexing process, audio data included in the video content data are analyzed to detect, for example, talk intervals included in the video content data and in which the person is talking. In the audio indexing process, for example, the characteristics of frequency spectrum of audio data are analyzed, and the talk intervals are detected in accordance with the characteristics of the frequency spectrum. In the talk interval detection process, for example, speaker segmentation technique or a speaker clustering technique is used to also detect switching among speakers. In one talk interval, the same speaker (or the same speaker group) talks continuously.

Furthermore, in the audio indexing process, a cheer level detection process and an excitement level detection process are executed; the cheer level detection process involves detecting a cheer level in each partial data (data with a given duration) of the video content data, and the excitement level detection process involves detecting an excitement level in each partial data of the video content data.

The cheer level indicates the level of cheer. The cheer is a mixture of many people's voices. A sound corresponding to a mixture of many people's voices has a particular frequency spectrum distribution. In the cheer level detection process, the frequency spectrum of audio data included in the video content data is analyzed. Then, the cheer level of each partial data is detected in accordance with the results of analysis of the frequency spectrum. The excitement level is the volume level of an interval in which at least a given volume level occurs continuously for at least a given duration. For example, the excitement level is the volume level of a sound such as relatively vigorous applause or loud laughter. In the excitement level detection process, the distribution of volume of the audio data included in the video content data is analyzed, and the excitement level of each partial data is detected in accordance with the results of the analysis.

The memory 111A is used as a work memory for the video processor 111. Executing the indexing process (video indexing process and audio indexing process) requires a large amount of calculation. In the present embodiment, the video processor 111, a dedicated processor different from CPU 101, is used as a backend processor to execute the indexing process. Thus, the indexing process can be executed without an increase in loads on CPU 101.

The sound controller 106 is a sound source device configured to output audio data to be reproduced, to the speakers 18A and 18B or the HDMI control circuit 3.

The wireless LAN controller 112 is a wireless communication device configured to carry out wireless communication according to, for example, IEEE 802.11. The IEEE 1394 controller 113 communicates with an external apparatus via a serial bus complying with the IEEE 1394 standard. For example, the IEEE 1394 controller 113 carries out communication required to load various video content data 401 recorded in an external video camera and record the video content data 401 in HDD 109.

EC/KBC 114 is a one-chip microcomputer in which an embedded controller configured to manage power and a keyboard controlled configured to control the keyboard 13 and the touchpad 16 are integrated. EC/KBC 114 provides a function to power on and off the computer 10 in response to the user's operation of the power button 14. EC/KBC 114 further provides a function to communicate with the remote control unit interface module 20.

The TV tuner 115 is a reception device configured to receive program data broadcast on broadcast waves and program data distributed through Internet moving image distribution services. The TV tuner 115 is connected to the input terminal 19. The TV tuner 115 is implemented as, for example, a digital TV tuner 115 capable of receiving digital broadcasting program data. The TV tuner 115 also provides a function to capture video data input by an external apparatus.

Now, the functional configuration of the TV application program 202 operating on the computer 10 configured as described above will be described.

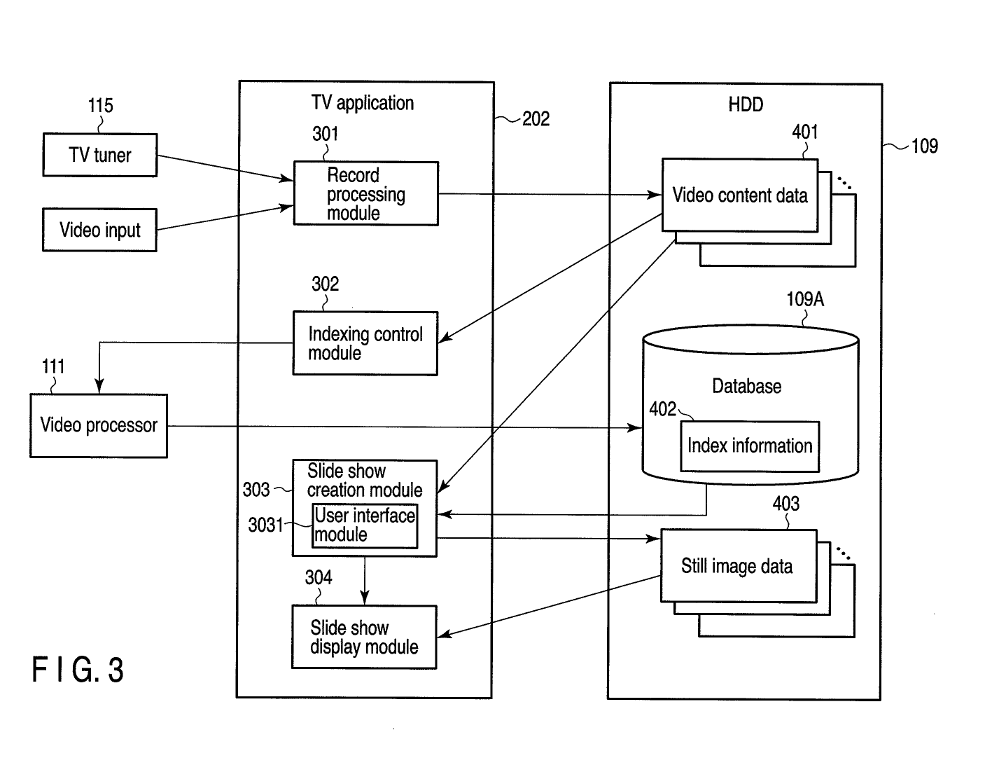

As shown in FIG. 3, the TV application program 202 includes a recording processing module 301, an indexing control module 302, a slide show creation module 303, and a slide show display module 304.

The recording processing module 301 executes a recording process of recording various video content data 401 such as program data received by the TV tuner 115 or video data input by an external apparatus, in HDD 109. The recording processing module 301 also executes a programmed recording process of using the TV tuner 115 to receive program data specified in recording programming information (channel number and date and time) preset by the user and recording the received program data in HDD 109.

The indexing control module 302 controls the video processor (indexing processing section) 111 so that the video processor 111 executes the above-described indexing processes (video indexing process and audio indexing process). The user can specify whether or not to execute the indexing process for each video content data 401. For example, the indexing process is automatically started after recording target program data to be subjected to the indexing process in accordance with an instruction has been recorded in HDD 109. Furthermore, the user can specify that the indexing process be executed on any portion of the video content data already stored in HDD 109.

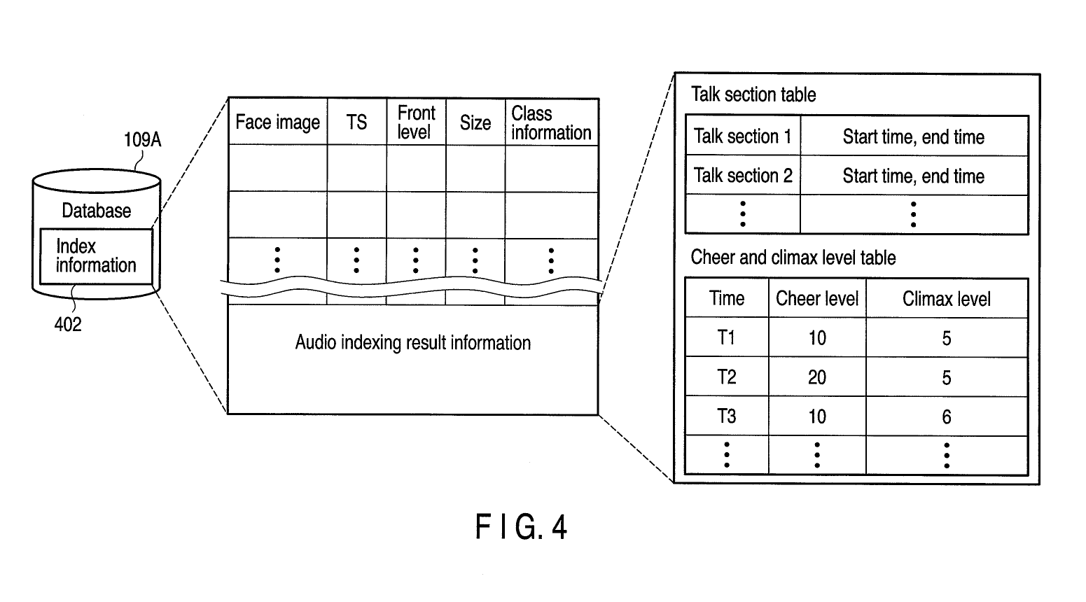

The results of the indexing process are stored in the database 109A as index information 402. The database 109A is a storage area prepared in HDD 109 to store the index information 402. FIG. 4 shows an example of the configuration of the index information 402 stored in the database 109A.

In the above-described video indexing process, the video processor 111 analyzes the moving image data included in the video content data 401 in units of frames and extracts a person's face images from a plurality of frames included in the moving image data. The video processor 111 further outputs time stamp information (TS) indicative of the point in time when each of the extracted face images appears in the video content data 401. The time stamp information corresponding to each face image may be, for example, elapsed time from the start of the video content data 401 until the face image appears or the number of the frame from which the face image has been extracted. In this case, the video processor 111 also outputs the front level and size of each extracted face image. The video processor 111 further classifies the extracted plurality of face images into different classes, that is, into image groups each showing the same person, and outputs the results of the classification as class information.

Thus, the results of the video indexing process (face images, time stamp information (TS), front level, size, and class information) output by the video processor 111 are stored in the database 109A as index information 402.

Furthermore, in the above-described audio indexing process, the video processor 111 analyzes the audio data included in the video content data to detect talk intervals contained in the video content data 401. The video processor 111 outputs a talk interval table in which information corresponding to each talk interval is stored. Moreover, in the audio indexing process, the video processor 111 executes the cheer level detection process and the excitement level detection process. The video processor 111 also outputs a cheer/excitement level table in which the results of the cheer level detection process and the excitement level detection process are stored.

The audio indexing process results (talk interval table and cheer/excitement level table) thus output by the video processor 111 are also stored in the database 109A as index information 402.

If a plurality of talk intervals are present between the start position and end position of the video content data 401, information corresponding to each of the plurality of talk intervals is stored in the talk interval table. In the talk interval table, start time information and end time information indicative of the start and end points, respectively, of each of the detected talk intervals are stored.

Furthermore, the cheer/excitement table is configured to store the cheer levels and excitement levels of partial data (time segments T1, T2, T3, . . . ) of the video content data 401 each of which has a given duration.

The above-described indexing process need not necessarily executed by the video processor 111. For example, the TV application program 202 may be provided with a function to execute the indexing process. In this case, the indexing process is executed by CPU 101 under the control of the TV application program 202.

The slide show creation module 303 executes an extraction process of using the index information 402 created through the indexing process to extract the images of frames (still image data 403) that meet predetermined extraction conditions, from the moving image data included in the video content data 401. The slide show display module 304 executes a display process of sequentially displaying the still image data 403 extracted by the slide show creation module 303, based on predetermined display conditions (in the same manner as that in which what is called a digital photo frame displays images). The principle of operations of the slide show creation module 303 and the slide show display module 304 will be described below in detail. In the present embodiment, sequential display of a plurality of still images is called a slide show. The slide show includes not only the simple sequential display of still images but also display of still images processed by, for example, applying a transition effect for display switching to the images.

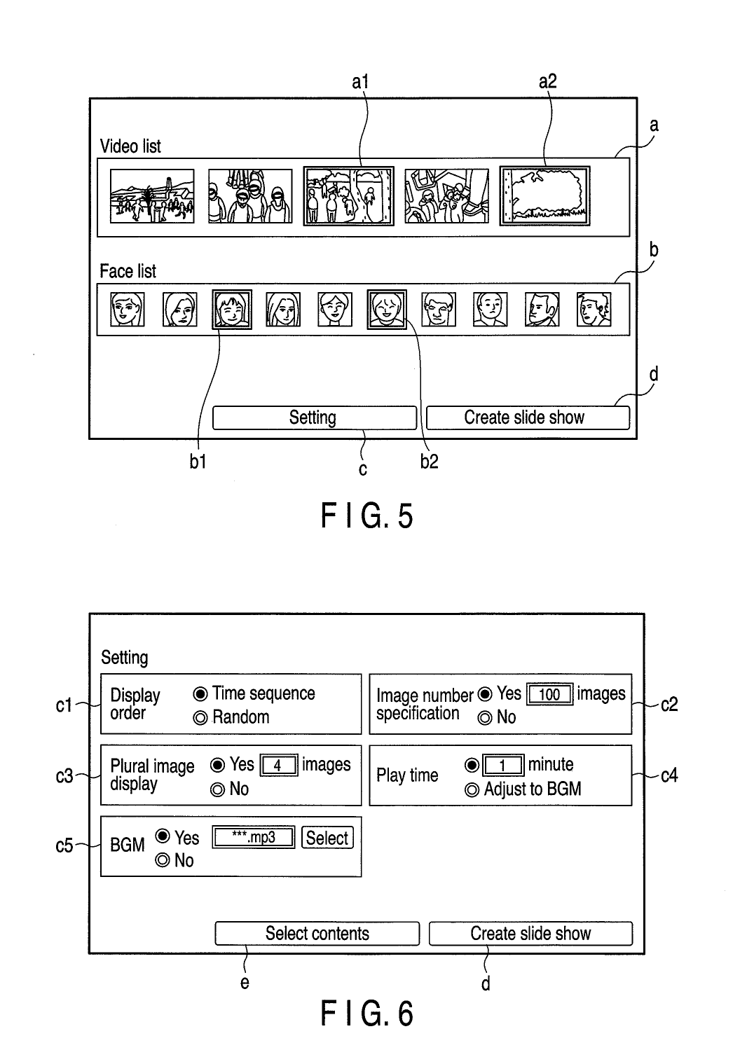

The slide show creation module 303 includes a user interface module 3031, and uses the user interface module 3031 to display a basic screen for slide show creation shown in FIG. 5 on LCD 17.

As shown in FIG. 5, the basic screen includes a video list display area “a” and a face list display area “b”. The slide show creation module 303 first selects a frame from the moving image data included in the video content data 401 recorded in HDD 109. The slide show creation module 303 then places a thumbnail image of the selected frame on the video list display area “a” as a typical image of the video content data 401 and as a choice. Various techniques for selecting a frame image serving as a typical image are applicable; a frame positioned at a point in time corresponding to a predetermined time after the start of the video content data 401 may be adopted. Furthermore, the video content data 401 corresponding to the thumbnail image placed on the video list display area “a” can be switched by operating the keyboard 13, the touchpad 16, or the like (this operation is performed, for example, if a large number of video content data 401 are recorded in HDD 109).

That is, when the display of the basic screen is started, thumbnail images serving as typical images of the video content data 401 recorded in HDD 109 are arranged on the video list display area “a” as choices, and the face list display area “b” is blank.

Then, when one of the thumbnail images on the video list display area “a” is selected by the user, the slide show creation module 303 uses the index information 402 stored in the database 109A in HDD 109 to place each of the face images of persons appearing in the video content data 401 corresponding to the thumbnail image, on the face list display area “b” as a choice. As shown in FIG. 4, the index information 402 includes the front level, the size, and the class information. Thus, the slide show creation module 303 selects, for each set of face images with the same class information, for example, one of the face images with a size equal to or larger than a threshold which has the highest front level. The front level may be a measure of the degree to which the face is visible (e.g., facing forward) in the image. Also or in addition, it may be measure of the degree to which it is in front of other faces or objects in the image (e.g., in the foreground). A plurality of thumbnail images on the video list display area “a” may be selected.

FIG. 5 shows a case in which two thumbnail images “a1” and “a2” of the thumbnail images arranged on the video list display area “a” are selected and in which, as a result, the face images of persons appearing in the video content data 401 corresponding to the thumbnail images “a1” and “a2” are placed on the face list display area “b”. The face images arranged on the face list display area “b” can also be switched by operating the keyboard, the touchpad 16, or the like (this operation is performed, for example, if a large number of video content data 401 on the video list display area are selected or a large number of persons appear in certain video content data 401).

Then, it is assumed that the user desires to view only the images of those scenes in the video content data 401 corresponding to the thumbnail images “a1” and “a2” selected on the video list display area “a” in which scenes the two persons shown in the face images “b1” and “b2” placed on the face list display area “b” appear. A “Create slide show” button “d” configured to specify creation of a slide show is provided on the basic screen displayed by the slide show creation module 303. Thus, the user selects the face images “b1” and “b2” on the face list display area “b”, and then operates the “Create slide show” button “d”.

As shown in FIG. 4, the index information 402 includes the time stamp information (TS) and the class information. Thus, upon undergoing the operation of the “Create slide show” button “d”, the slide show creation module 303 determines, based on the time stamp information, frames from which face images with the same class information as that on the selected face images “b1” and “b2”. The slide show creation module 303 extracts the images of the frames from the moving image data included in the video content data 401. The slide show creation module 303 then records the images in HDD 109 as still image data 403. The slide show display module 304 then displays the still image data 403 extracted by the slide show creation module 303 from the moving image data included in the video content data 401 and recorded in HDD 109, on LCD 17 in the same manner as that in which what is called a digital photo frame displays images.

Furthermore, a “Setting” button “c” configured to set various conditions for slide shows is provided on the basic screen displayed by the slide show creation module 303. When the “Setting” button “c” is operated, the slide show creation module 303 uses the user interface module 3031 to display a setting screen for slide show creation shown in FIG. 6, on LCD 17.

As shown in FIG. 6, a display order area “c1”, an image number specification area “c2”, plural image display area “c3”, a play time area “c4”, and a BGM area “c5” are provided on the setting screen.

The display order area “c1” is an area in which whether to display the still image data 403 in order of appearance in the video content data 401 (time sequence) or randomly (random) regardless of the order of appearance in the video content data is specified.

The image number specification area “c2” is an area in which the number (the number of images to be displayed) of still image data 403 to be extracted from the video content data 401 for display is set. When No is set in the image number specification area “c2”, the images of frames containing the face images with the same class information as that on the face images selected on the face list display area “b” of the basic screen shown in FIG. 5 are all extracted and displayed. On the other hand, when “Yes” is set, the extraction and display operation is performed, for example, in order of (1) decreasing size and (2) decreasing front level with the specified number of images used as an upper limit. Furthermore, if a plurality of face images are selected on the face list display area “b” of the basic screen shown in FIG. 5, the upper limit on the number of images is assigned to each of the persons so that the numbers are uniform. If the number of times that a certain person appears fails to reach the assigned upper limit, the number of images corresponding to the insufficiency is reassigned to other persons.

The plural image display area “c3” is an area in which the number of still image data 403 arranged on one screen so as to be synthetically displayed (the number of images to be synthetically displayed) is set. Furthermore, the play time area “c4” is an area in which the total display time for the still image data 403 is set. As shown in FIG. 6, with 100 images set on the image number specification area “c2” (up to 100 images is extracted), when four images are specified on the plural number display area “c3” and one minute is specified on the play time area “c4”, the screen is switched every 2.4 seconds=(1 minute/100 images)×4 images.

Furthermore, when “Adjust to BGM” is set on the play time area “c4”, the total play time for audio data selected in the BGM area “c5” is set to be the total display time for the still image data 403. The BGM area “c5” is an area in which whether or not to reproduce the audio data as background music when the still image data 403 is displayed is specified. If “Yes” is set in the BGM area “c5”, any of the audio data recorded in HDD 109 can be selected. If instead of “Adjust to BGM”, one minute is set on the play time area “c4” as shown in FIG. 6, the audio data selected on the BGM area “c5” is reproduced for one minute starting with the leading position of the data.

A “Select contents” button “e” configured to allow return to the basic screen shown in FIG. 5 is provided on the setting screen with the above-described setting item areas. Operating the “Select contents” button “e” allows the operation of selecting the video content data 401 or persons to be resumed. Furthermore, the “Create slide show” button “d” is provided on the setting screen as in the case of the basic screen shown in FIG. 5. Thus, the user can specify creation and display of a slide show without the need to return to the basic screen shown in FIG. 5. The slide show creation module 303 notifies the slide show display module 304 of information on the slide show display conditions set on the setting screen.

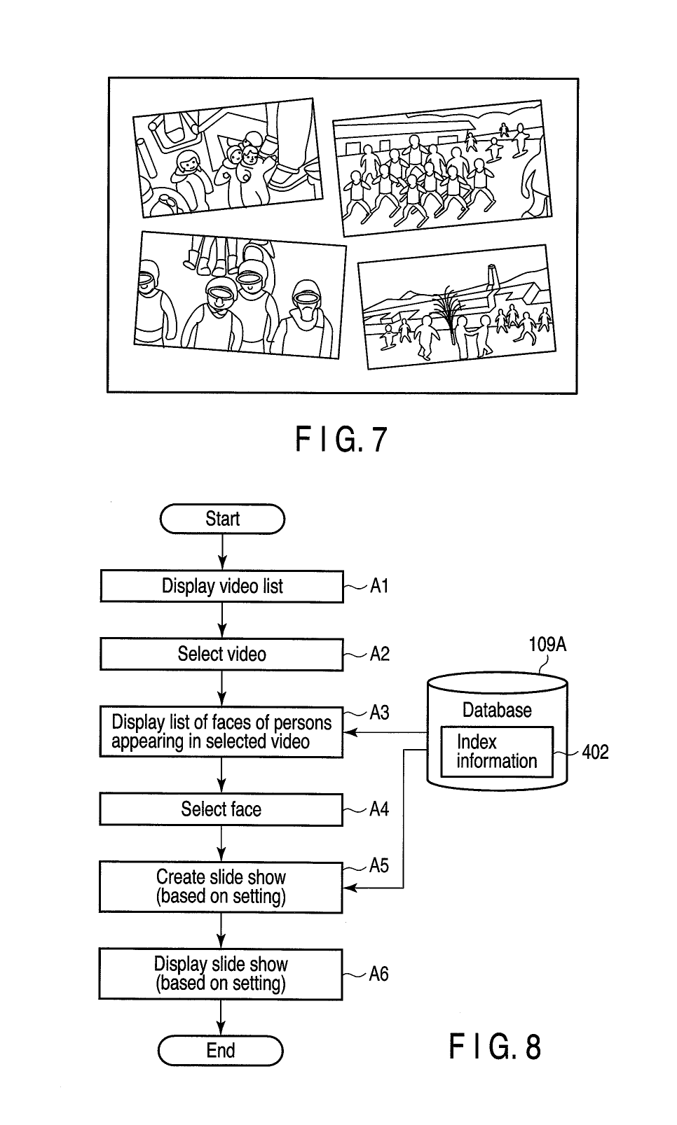

As described above, based on the extraction conditions set on the basic screen shown in FIG. 5 and on the setting screen shown in FIG. 6, the slide show creation module 303 uses the index information 402 to extract the still image data 403 from the video content data 401. Then, based on the display conditions set on the setting screen shown in FIG. 6, the slide show display module 304 sequentially displays the still image data 403 extracted by the slide show creation module 303. FIG. 7 shows an example of display of a slide show provided by the slide show display module 304.

Since the four images are set on the plural image display area “c3” of the setting screen shown in FIG. 6, four images are arranged and displayed on one screen. The thus displayed still image data 403 correspond to the images of those of the frames in the moving image data included in the video content data 401 which correspond to the thumbnail images “a1” an “a2” selected on the video list display area “a” of the basic screen shown in FIG. 5, that is, the frames in which the persons shown in the face images “b1” and “b2” selected on the face list display area “b” of the basic screen shown in FIG. 5 appear. Furthermore, these images are displayed in order of appearance in the video content data (because “time sequence” is set on the display order area “c1” of the setting screen c1 shown in FIG. 6) so that each set of the image frames is displayed for 2.4 seconds (because 100 images, four images, and 1 minute are specified on the image number specification area “c2”, plural image display area “c3”, and play time area “c4”, respectively, of the setting screen shown in FIG. 6).

Mechanism for setting the display conditions is not limited to the method of specifying each of the conditions using the above-described setting screen but may be, for example, a method of selecting a theme for which the display conditions are preset.

Specific display conditions are set for each theme, and the themes are provided with names that the user can easily imagine, such as “bustling” and “slowly”, and are displayed on a selection screen. For example, the theme “bustling” involves music data appropriate for this theme and the corresponding total display time. Settings for the theme “bustling” include a large number of images to be displayed, a large number of images to be synthetically displayed, and quick switching among a large number of photographs.

Now, with reference to the flowchart in FIG. 8, the procedure of a process of creating and displaying a slide show which process is executed by the TV application program 202.

The TV application program 202 first displays the video content data 401 recorded in HDD 109, in a list as choices (block A1). When any of the video content data 401 displayed in the list is selected (block A2), the TV application program 202 uses the index information 402 stored in the database 109A in HDD 109 to display the face images of persons appearing in the selected content data 401, in a list as choices (block A3).

When any of the face images displayed in the list is selected (block A4), the TV application program 202 uses the index information 402 stored in the database 109A in HDD 109 to extract the images of persons shown in the selected face images from the (selected) video content data 401. The TV application program 202 then stores the images in HDD 109 as still image data 403 (block A5). The TV application program 202 then sequentially displays the still image data 403 stored in HDD 109, on LCD 17 (block A6).

Thus, the computer 10 allows the user to effectively display only the scenes of the moving image which meet the predetermined conditions by easy operations.

In the above-described example, when the index information 402 stored in the database 109A in HDD 109 is used to extract the still image data from the moving image data included in the video content data 401 and display the still image data, the face images of the persons appearing in the selected video content data 401 is displayed in a list. However, the usage of the index information 402 (for extracting the still image data 403 from the moving image data included in the video content data 401) is not limited to this aspect and may be varied.

For example, a table adapted to associate the class information on the face images with the persons' names may be stored in the database 109A as index information 402. Thus, the persons' names may be displayed in a list as choices. To manage this table, user interface mechanism may be provided which allows the face images to be displayed in a list so that the user can input the name of any of the persons.

Furthermore, for example, since the audio indexing process results are also stored in the database 109A as index information 402, the images of frames may be easily extracted which are arranged in “talk intervals” and which have a high cheer/excitement level. Alternatively, in contrast, the images of frames arranged outside the “talk intervals” may be easily extracted. Furthermore, the created slide show may be output to a moving image file or the like instead of being displayed on LCD.

### Second Embodiment

Now, a second embodiment will be described. The configuration of an electronic apparatus (computer 10) according to the second embodiment is similar to that according to the first embodiment and will thus not be described.

In the second embodiment, in a video indexing process, a video processor 111 executes a process for acquiring thumbnail images concurrently with the above-described extraction of face images. The thumbnail images corresponding to the respective plurality of frames extracted from video content data, for example, at equal time intervals.

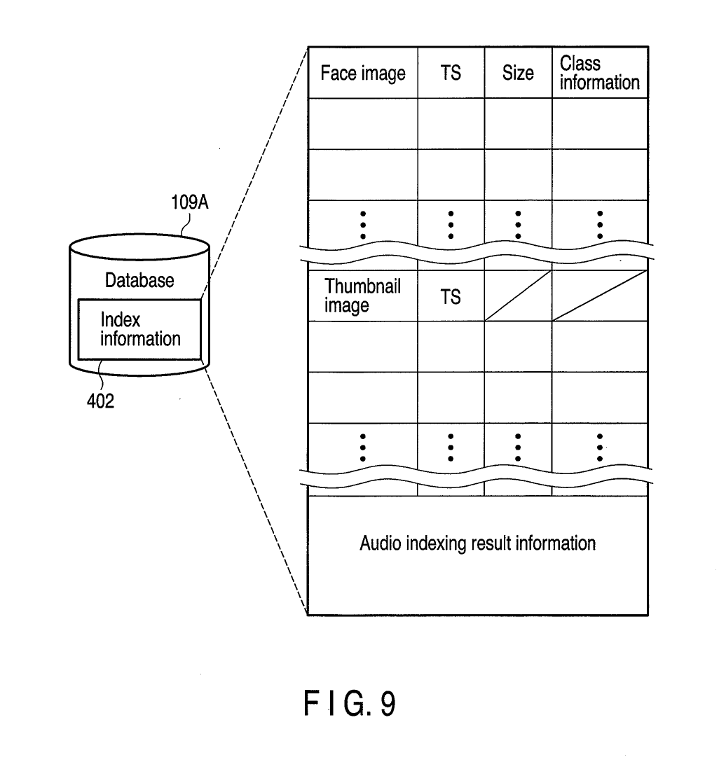

That is, the video processor 111 according to the second embodiment sequentially extracts frames from video content data 401, for example, at equal time intervals regardless of whether or not the frame contains a face image. The video processor 111 further outputs an image (thumbnail image) corresponding to each of the extracted frames and time stamp information (TS) indicative of a point in time when the thumbnail image appears. As shown in FIG. 9, the results of the thumbnail image acquisition process (thumbnail images and time stamp information [TS]) output by the video processor 111 are also stored in the database 109A as index information 402 according to the second embodiment.

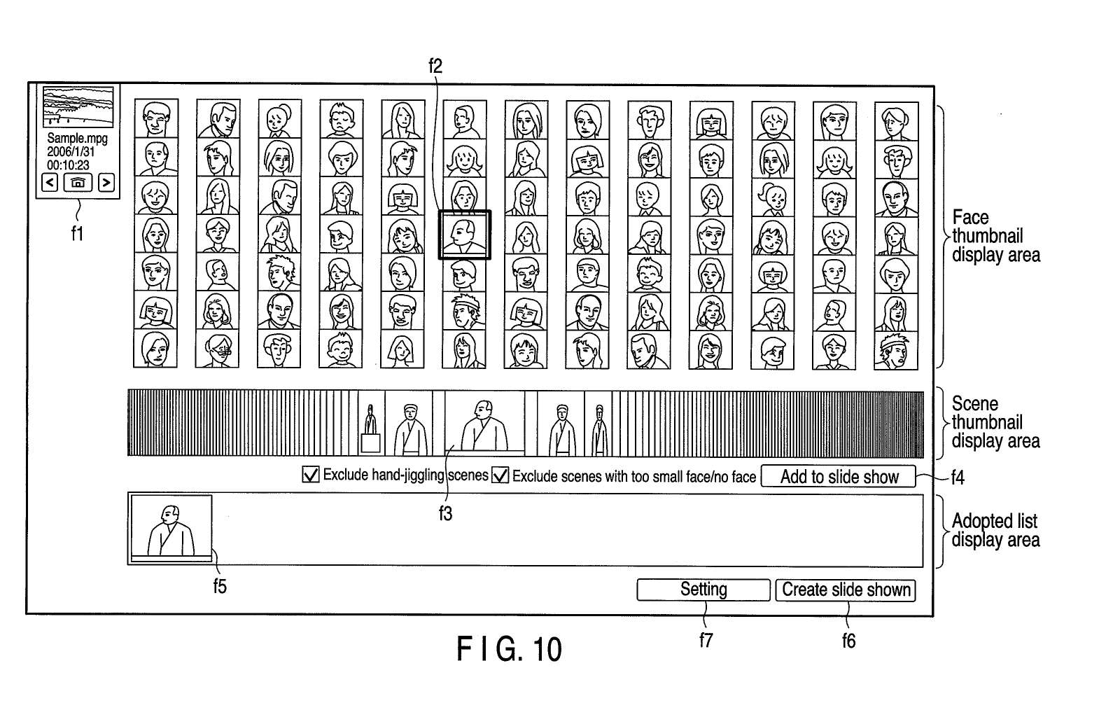

FIG. 10 is an exemplary diagram showing an example of a basic screen for slide show creation displayed on LCD 17 by a slide show creation module 303 using index information 402 including the results of the thumbnail image acquisition process.

As shown in FIG. 10, the basic screen according to the second embodiment includes a face thumbnail display area in which a list of face images is displayed and a scene thumbnail display area in which a list of thumbnail images is displayed in accordion form. Here, the accordion form is a display form in which a selected thumbnail image is displayed in a normal size, with each of the other thumbnail images reduced in a lateral size. In FIG. 10, the lateral size of each of the other thumbnail images decreases with increasing distance from the selected thumbnail image. The number of thumbnail images displayed in the scene thumbnail display area is set to one of, for example, 240, 144, 96, and 48 in accordance with the user's setting. The default is, for example, 240.

The face thumbnail display area includes a plurality of face image display areas arranged in a matrix including a plurality of rows and a plurality of columns. Each of a plurality of time zones is assigned to a corresponding one of the rows; the time zones are obtained, for example, by dividing the total duration of the video content data 401 into shorter durations the number of which is equal to that of the columns, and have the same duration T. Thus, the duration T of each time zone varies depending on the total duration of the video content data 401.

The basic screen according to the second embodiment includes a video section area “f1” used to select any one of the video content data 401 recorded in HDD 109. For the video content data 401 selected in the video selection area “f1”, based on the time stamp information corresponding to each of the face images extracted by the video processor 111, a slide show creation module 303 places the face images belonging to the time zone assigned to each column, on the respective plurality of face image display areas in the column. That is, the slide show creation module 303 selects face images corresponding to the number of the rows from the face images belonging to the time zone assigned to each column. The slide show creation module 303 then arranges the selected face images corresponding to the number of the rows in a time sequential manner.

Now, the relationship between the face thumbnail display area and the scene thumbnail display area will be described. When one of the face images on the face thumbnail display area is selected by the user, the slide show creation module 303 controllably displays the thumbnail images in the thumbnail display area so as to display, in the normal size (which indicates that the corresponding image has been selected), the thumbnail image corresponding to the time zone including the time indicated by the time stamp information on the face image.

FIG. 10 shows an example in which a face image “f2” has been selected from the face images arranged on the face thumbnail display area and in which, as a result, a thumbnail image “f3” corresponding to the time zone including the time indicated by the time stamp information on the face image “f2” has been displayed in the normal size. Furthermore, an “Add to slide show” button “f4” is provided on the basic screen according to the second embodiment. Operating the “Add to slide show” button “f4” allows the thumbnail image “f3” displayed on the scene thumbnail display area in the normal size to be also displayed on an adopted list display area (thumbnail image “f5”). In the adopted list display area, still image data 403 to be extracted from the video content data 401 selected in the video selection area “f1” are displayed in a list. Every time the “Add to slide show” button “f4” is operated, the thumbnail image displayed on the scene thumbnail display area in the normal size is additionally placed on the adopted list display area.

Once all the desired thumbnail images are arranged on the adopted list display area, the user operates a “Create slide show” button “f6” configured to specify creation of a slide show, to specify creation and display of a slide show comprising the thumbnail images displayed on the adopted list display area, as is the case with the above-described first embodiment. As shown in FIG. 9, the index information 402 includes the time stamp information (TS) on the thumbnail images. Thus, upon undergoing this operation, the slide show creation module 303 determines the frames of the thumbnail images displayed on the adopted list display area based on the time stamp information. The slide show creation module 303 extracts the frames of the images from the moving image data included in the video content data 401. The slide show creation module 303 then records the frames in HDD 109 as still image data 403. Then, a slide show display module 304 sequentially displays the still image data 403 extracted from the moving image data included in the video content data 401 and recorded in HDD 109, by the slide show creation module 303, in the same manner as that in which what is called a digital photo frame displays images. Furthermore, as is the case with the first embodiment, the user can operate a “Setting” button “f7” to (display a setting screen and) set display conditions.

Furthermore, an “Exclude hand-jiggling scenes” box and a “Exclude scenes with too small face/no face” box are provided on the basic screen according to the second embodiment. When the “Exclude hand-jiggling scenes” box is checked, the slide show creation module 303 excludes the thumbnail images in scenes assumed to undergo hand jiggling from the targets to be placed on the scene thumbnail display area. Thus, in a video indexing process, the video processor 111 analyzes the characteristics of each frame image to detect hand-jiggling intervals in accordance with the characteristics. The video processor 111 then outputs a hand-jiggling interval table in which start time information and end time information indicative of the start and end points, respectively, of each of the detected hand-jiggling intervals are stored. The hand-jigging interval table is stored in the database 109A as index information 402. When the “Exclude hand-jiggling scenes” box is checked, the slide show creation module 303 references the hand-jiggling interval table to recognize scenes to be excluded from the targets to be placed on the scene thumbnail display area.

Furthermore, if the “Exclude scenes with too small face/no face” box is checked, the slide show creation module 303 references the index information 402 exclude, from the targets to be placed on the scene thumbnail display area, (1) scenes for which no face image is stored in HDD 109 and (2) scenes for which a face image is stored in HDD 109 but is too small in size.

In the basic screen according to the second embodiment, selecting any of the face images arranged on the face thumbnail display area enables not only selection of any of the thumbnail images on the scene thumbnail display area but also direct selection of the desired ones of the thumbnail images on the scene thumbnail display area. Thus, when any of the face images arranged on the face thumbnail display area is selected, then after temporary selection of any of the thumbnail images on the scene thumbnail display area, the thumbnail image displayed on the scene thumbnail display area in the normal size can be switched forward or backward.

Thus, the second embodiment also facilitates the operation of using the index information 402 stored in the database 109A to extract the still image data 403 from the moving image data included in the video content data 401 and display the still image data 403 in the same manner as that in which what is called a digital photo frame displays images.

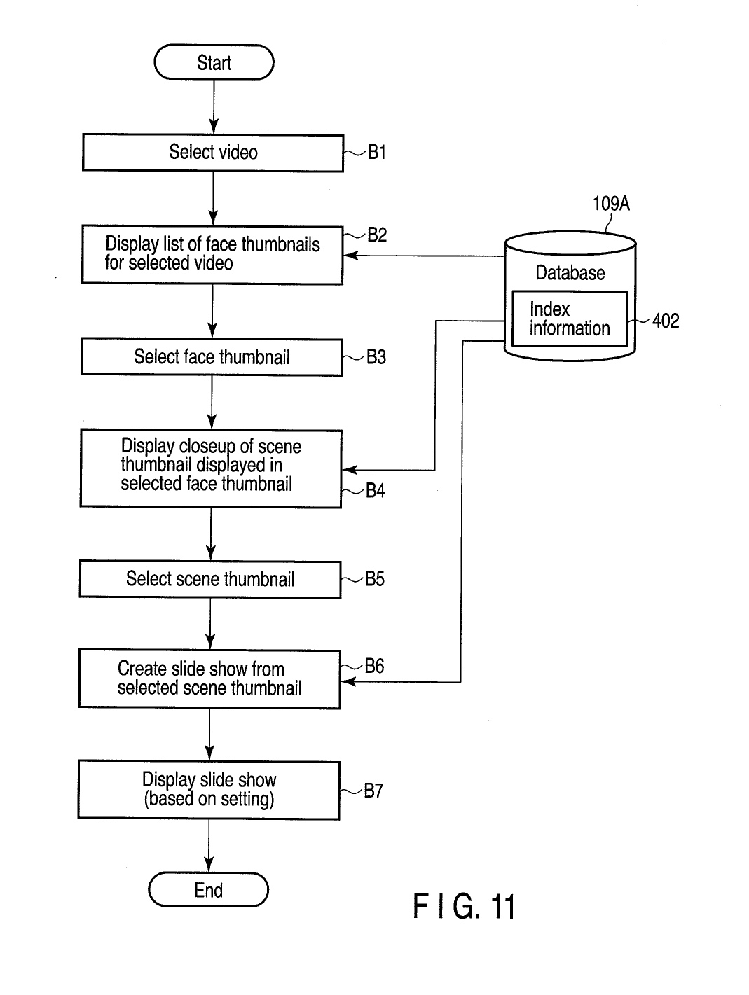

Now, with reference to the flowchart in FIG. 11, the procedure of a process for creating and displaying a slide show which process is executed by the TV application program 202 according to the second embodiment.

When any of the video content data 401 recorded in HDD 109 is selected (block B1), the TV application program 202 uses the index information 402 stored in the database 109A in HDD 109 to display the face images in the selected video content data 401, in a list as choices (block B2). When any of the face images displayed in the list is selected (block B3), TV application program 202 uses the index information 402 stored in the database 109A in HDD 109 to controllably display, in the normal size, a thumbnail image corresponding to a time zone including the time of the frame in which the selected face image appears (block B4).

Every time the operation of adopting a thumbnail image displayed in the normal size is performed, the TV application program 202 adds the frame of this thumbnail image to the extraction and display targets (block B5). The TV application program 202 uses the index information 402 stored in the database 109A in HDD 109 to extract and store the image of the frame of the adopted thumbnail image, in HDD 109 as still mage data 403 (block B6). The TV application program 202 then sequentially displays the still image data 403 stored in HDD 109, on LCD 17.

As described above, the computer 10 according to the second embodiment also allows the user to effectively display only the scenes of the moving image which meet the predetermined conditions by easy operations.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an indexing module configured to create index information for video data;
a frame image extraction module configured to extract an image of a frame satisfying a predetermined extraction condition from the video data based on the index information; and
a display controller configured to cause the display of the extracted image based on a predetermined display condition.

2. The apparatus of claim 1,
further comprising a user interface module configured to display face images in the video data for selecting a classification based on the index information in such a manner that a face image is displayed for a classification, the index information comprising time stamp information indicative of a position in the video data of a frame comprising a face image of a person and class information on a face image,
wherein the frame image extraction module is configured to extract the image of the frame comprising a face image belonging to the selected classification.

3. The apparatus of claim 2, wherein the user interface module is further configured to cause the display of thumbnail images for each of at least one frame selected from each video, to allow one of the thumbnail images to be selected and to cause the display of face images extracted from the videos and associated with a class associated with the selected image
wherein the user interface module is configured to display thumbnail images for one frame selected from each video data, and to display face images belonging to the classification appearing in the video data corresponding to a thumbnail image selected from the displayed thumbnail images.

4. The apparatus of claim 2, wherein:
the user interface module allows one or more images to be selected;
the display condition comprises a number of images to be displayed; and
the frame image extraction module is configured to extract images of frames based on the selected number of face images and the number of images to be displayed.

5. The apparatus of claim 1, further comprising a user interface module configured to display a setting screen for specifying a number of images to be displayed on one screen, wherein the display controller is configured to display extracted images in sets of one or more screens, such that the number of images displayed on one screen is equal to the specified number of images.

6. The apparatus of claim 5, wherein the display controller is configured to control a display interval between screens based on the specified number of images to be displayed on one screen and a predefined total display time.

7. The apparatus of claim 5, wherein:
the display condition comprises audio data for a background music, the audio data associated with a time; and
the display controller is further configured to control a display interval based on the time.

8. The apparatus of claim 1, further comprising a user interface module configured to display a setting screen for specifying whether to display the extracted images in a time sequential order or in a random order,
wherein the display controller is configured to cause the display of the extracted images in the specified display order.

9. The apparatus of claim 2, wherein:
the index information comprises Depe level information associated with face images; and
the frame image extraction module is configured to preferentially extract the image of a frame comprising a face image associated with a high front level from the moving image data.

10. The apparatus of claim 9, wherein front level information comprises information corresponding to a measure of how much of the face in image is facing forward.

11. The apparatus of claim 2, wherein:
the index information comprises size information associated with face images; and
the frame image extraction module is configured to preferentially extract the image of a frame comprising a large-sized face image.

12. The apparatus of claim 2, wherein:
the index information comprises size information associated with face images; and
the frame image extraction module is configured to preferentially extract the image of a frame comprising a face image associated with a large size over one comprising a face image associated with a smaller size.

13. An electronic apparatus comprising:
a face list display module configured to display face images of persons, the face images extracted from frames of moving image data;
a thumbnail display module configured to display a thumbnail image corresponding to a frame comprising a face image selected from the face images displayed by the face list display module;
an instruction module configured to instruct that an image of a frame corresponding to the thumbnail image displayed by the thumbnail display module be adopted as a display target;
an adopted list display module configured to display thumbnail images adopted by the instruction module;
a frame image extraction module configured to extract images of frames corresponding to the thumbnail images displayed by the adopted list display module from the moving image data; and
a display controller configured to cause the display the extracted images based on a predetermined display condition.

14. An image data display method of an electronic apparatus comprising a storage medium in which moving image data is recorded, the method comprising:
accessing moving image data stored on a computer readable medium;
creating index information for the moving image data;
extracting an image of a frame satisfying a predetermined extraction condition from the moving image data based on the created index information; and
displaying the extracted image based on a predetermined display condition.
